(19) United States
(12) Patent Application Publication
(10) Pub. No.: US 2020/0245666 A1
(43) Pub. Date: Aug. 6, 2020

(54) CANNABINOID EMULSIONS, BEVERAGES AND FOODS

(71) Applicant: Lighthouse Strategies, LLC, San Diego, CA (US)

(72) Inventors: Junaid Ahmad Spall, San Diego, CA (US); Kevin Barnes, San DIego, CA (US); Michael B. Hayford, San Diego, CA (US)

(21) Appl. No.: 16/776,307

(22) Filed: Jan. 29, 2020

Related U.S. Application Data
(60) Provisional application No. 62/801,952, filed on Feb. 6, 2019.
(60) Provisional application No. 62/900,073, filed on Sep. 13, 2019.

(51) Int. Cl. A23L 33/105; C12C 12/04; A23L 2/52

(52) U.S. Cl. CPC A23L 33/105; A23L 2/52; C12C 12/04

(57) ABSTRACT

Provided is a method of preparing cannabinoid emulsions. Also provided is a method of preparing beverages comprising cannabinoid nanoemulsions. Further provided are nanoemulsions and beverages made by the above methods. Additionally provided is a method of packaging, in a metallic container having a liner, a liquid with a hydrophobic agent in an emulsion. Further provided is a liquid packaged by the method described immediately above. Also provided is solid food comprising a cannabinoid nanoemulsion. Additionally provided is a method of producing a food or beverage with a cannabinoid that has a longer duration cannabinoid effect than the cannabinoid when in a single size nanoemulsion or microemulsion.

### CROSS-REFERENCE TO RELATED APPLICATIONS

This application claims the benefit of U.S. Provisional Application No. 62/801,952, filed Feb. 6, 2019, and U.S. Provisional Application No. 62/900,073, filed Sep. 13, 2019, both of which are incorporated by reference herein in its entirety.

### BACKGROUND OF THE INVENTION

### (1) Field of the Invention

The present application generally relates to the production of cannabinoid-infused products. More specifically, cannabinoid emulsions, and beverages and foods infused with cannabinoid emulsions, are provided.

### (2) Description of the Related Art

Cannabis is a flowering plant that is used industrially, such as for fiber (e.g., hemp rope) and oils, as well as medicinally and recreationally.

Cannabis plants can produce and include secondary metabolites called cannabinoids. Cannabinoids, terpenoids, and other compounds can be secreted by glandular trichomes of plants. There are at least 483 identifiable chemical constituents known to exist in the Cannabis plant (Brenneisen, 2007) and at least 85 different cannabinoids have been isolated from the plant (El-Alfy et al., 2010). The two cannabinoids usually produced in greatest abundance are cannabidiol (CBD) and/or Δ9-tetrahydrocannabinol (THC).

Cannabinoids are hydrophobic, non-polar molecules with a low solubility in water, making their transport across the hydrolipidic layer of skin a rate-limiting step during diffusion. Details regarding the hydrophobicity of cannabinoids are set forth, for example, in Scheuplein (1967) and Challapalli and Stinchcomb (2002). When cannabinoids are ingested orally (i.e., eaten), they are broken down into metabolites via the stomach and liver before entering the bloodstream. For example, when THC is ingested orally, it is converted in the stomach, via metabolism, into 11-Hydroxy-THC (also referred to as “11-OH-THC”), which can more readily/effectively cross the blood-brain barrier (BBB), and which has been shown to be more psychoactive than THC. Cannabis is metabolized first by stomach enzymes and then by the liver, creating two opportunities for the creation of 11-hydroxy-THC. However, the process of THC breaking down into metabolites by the stomach and liver can take multiple hours, resulting in a delayed onset of the effect(s) of the THC on the consumer. In anticipation of this delayed onset, consumers may under-titrate or over-titrate their dosage, leading to an undesired lack of effect or an undesired overly-intense effect, respectively. Consumers of cannabinoid containing edibles often report a “first pass effect” (also known as “first-pass metabolism,” or “presystemic metabolism”)—a phenomenon of drug metabolism whereby the concentration of a drug is greatly reduced before it reaches the systemic circulation. First pass effect can be defined as the rapid uptake and metabolism of an agent into inactive compounds by the liver, immediately after enteric absorption and before it reaches the systemic circulation. Scientific studies generally rate edibles as having a bioavailability of between 4-20%, with THC bioavailability averaging 30%. See, e.g., McGilveray (2005), finding that orally consumed THC is only 4% to 12% bioavailable.

Smoking is another consumption method. Smoking carries the risk of carcinogenic effects due to the formation of deleterious compounds during combustion, and there are many laws prohibiting smoking in public. Moreover, many consumers (e.g., non-smokers) find smoking Cannabis unpleasant and/or aesthetically unpleasing. When Cannabis smoke is inhaled, it goes directly to the lungs, where it enters the bloodstream directly, circumventing other organs, such as the liver, at first. The THC still present in the blood that eventually makes it to the liver is metabolized into 11-Hydroxy-THC (a hydroxy metabolite), however relatively little is produced. See, e.g., McGilveray (2005), finding that THC consumed through combustion (i.e., smoking) has an average bioavailability of about 30%; smoking a 3.55% THC cigarette resulted in a peak plasma level of 152±86.3 ng/mL, approximately 10 minutes after inhalation.

THC plasma concentrations can decrease rapidly after smoking ends, due to rapid distribution into tissues and metabolism in the liver. THC is highly lipophilic and initially taken up by tissues that are highly perfused, such as the lung, heart, brain, and liver. Tracer doses of radioactive THC have been used to document the large volume of distribution of THC and its slow elimination from body stores; higher levels were found in lung than other tissues (Lemberger et al., 1970).

During vaping, as during smoking, cannabinoids are absorbed via the lungs, but potentially with fewer harmful side effects since what is being inhaled is vapor, rather than smoke. Vaporizing can greatly affect the bioavailability of THC and CBD, with certain vaporizers having bioavailability of 50-80% (Lanz, 2016).

Thus, there is a need for food and beverage products infused with cannabinoid(s) where the cannabinoids are more bioavailable and have faster onset and offset, and are more stable in the food or beverage product, than currently available products. The present invention satisfies that need.

### BRIEF SUMMARY OF THE INVENTION

Provided is a method comprising: freezing a portion of a Cannabis plant to produce frozen Cannabis, wherein the Cannabis plant comprises at least one cannabinoid; submerging the frozen Cannabis in at least 95% ethanol to produce a mixture; storing the mixture for a duration sufficient to convert the ethanol into an ethanol-cannabinoid solution; removing the ethanol-cannabinoid solution from the mixture; concentrating the ethanol-cannabinoid solution using an evaporator, to produce a concentrated ethanol-cannabinoid solution; distilling the concentrated ethanol-cannabinoid solution to an ethanol concentration of between about 5% and about 10%, to produce a cannabinoid concentrate; heating the cannabinoid concentrate sufficient to decarboxylate the cannabinoid concentrate; performing a distillation of the cannabinoid concentrate; adding an oil comprising C14 triglycerides to the distilled cannabinoid concentrate; and processing the cannabinoid concentrate to form a cannabinoid emulsion.

Also provided is a method comprising: de-alcoholizing beer to form a non-alcohol cereal beverage; rectifying the non-alcohol cereal beverage by adding the cannabinoid nanoemulsion of any one of claims 1-16, to the non-alcoholic cereal beverage; and homogenizing the cannabinoid-infused cereal beverage.

Additionally provided is a method, comprising: providing a beverage; adjusting a pH of the beverage to a predetermined pH value; infusing the pH-adjusted beverage with the cannabinoid emulsion of any one of claims 1-16; and carbonating the infused beverage to a desired CO₂ volume, to produce a cannabinoid-infused carbonated beverage.

Further provided is a nanoemulsion made by the above-described method.

Also provided is a beverage comprising the above-described nanoemulsion.

Additionally provided is a method of packaging a liquid in a metallic container having a liner, the method comprising adding the liquid and an oil emulsion to the metallic container, wherein the liquid comprises a hydrophobic agent in an emulsion; and the hydrophobic agent is available for ingestion in the liquid for a longer time than if the oil emulsion was not added.

Further provided is a beverage packaged by the method described immediately above.

Also provided is solid food comprising a cannabinoid nanoemulsion.

Additionally provided is a method of producing a food or beverage with a cannabinoid that has a longer duration cannabinoid effect than the cannabinoid when in a single size nanoemulsion or microemulsion, the method comprising: combining a nanoemulsion with a microemulsion of the cannabinoid and produce the food or beverage with that combined nanoemulsion/microemulsion.

### BRIEF DESCRIPTION OF THE SEVERAL VIEWS OF THE DRAWINGS

FIG. 1 is a diagram showing an oil droplet in water, within an emulsion.

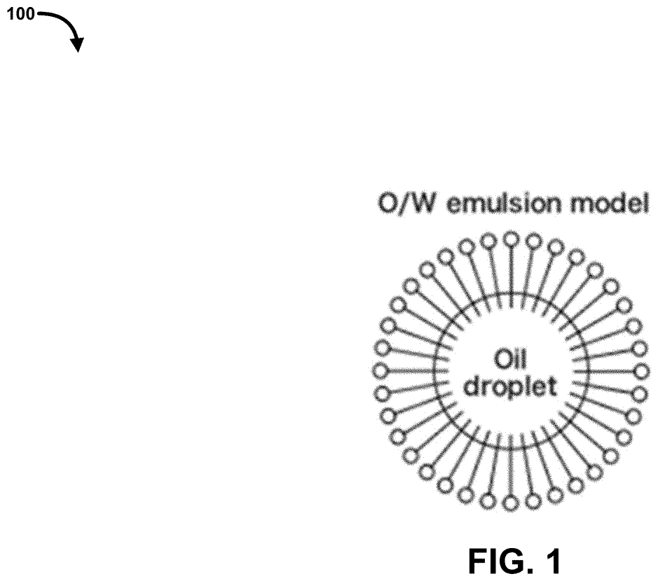

FIG. 2 illustrates the chemical reaction of decarboxylation.

FIG. 3 is a diagram showing a method of preparing a cannabinoid nanoemulsion, according to some embodiments.

FIG. 4 is a photograph of an example glass chromatography column, according to an implementation.

FIG. 5 is a diagram showing a method of preparing a cannabinoid-infused cereal beverage, according to some embodiments.

FIG. 6 is a diagram showing a method of preparing a cannabinoid-infused carbonated beverage, according to some embodiments.

### DETAILED DESCRIPTION OF THE INVENTION

Provided herewith are Cannabis nanoemulsions, methods of making those nanoemulsions, and beverages and foods comprising those nanoemulsions.

Cannabinoids according to the present disclosure can include, while not being limited to those obtained or obtainable from Cannabis plants, which can include, by way of non-limiting example: Δ9-tetrahydrocannabinol (Δ9-THC), Δ8-tetrahydrocannabinol (Δ8-THC), cannabichromene (CBC), cannabicyclol (CBL), cannabidiol (CBD), cannabielsoin (CBE), cannabigerol (CBG), cannabinidiol (CBND), cannabinol (CBN), cannabitriol (CBT), and their propyl homologs, including, by way of non-limiting example cannabidivarin (CBDV), Δ9-tetrahydrocannabivarin (THCV), cannabichromevarin (CBCV), and cannabigerovarin (CBGV).

Cannabinoids according to the disclosure can also include those produced by plants (also known as phytocannabinoids, natural cannabinoids, herbal cannabinoids, or classical cannabinoids). Cannabinoids of the disclosure can additionally include synthetic cannabinoids, and/or cannabinoids isolated from Cannabis plants, by way of non-limiting example, tetrahydrocannabinol (THC), cannabidiol (CBD) (e.g., derived from Cannabis indica, Cannabis ruderalis, or Cannabis sativa (“hemp”)), CBG (cannabigerol), CBC (cannabichromene), CBL (cannabicyclol), CBV (cannabivarin), THCV (tetrahydrocannabivarin), CBDV (cannabidivarin), CBCV (cannabichromevarin), CBGV (cannabigerovarin), and CBGM (cannabigerol monomethyl ether).

### Cannabinoid Emulsions

In some embodiments, the present invention is directed to cannabinoid emulsions and methods of making those emulsions. These emulsions, particularly nanoemulsions, when incorporated into a food or beverage, can provide cannabinoids that are highly available physiologically such that physiological effects of the cannabinoids are achieved more quickly (faster onset), dissipate more quickly (faster offset) and require a smaller dose than the food or beverage having cannabinoids that are not in a nanoemulsion.

An emulsion is a dispersion of droplets of one liquid in another liquid. An emulsion can be a nanoemulsion or a microemulsion. A “nanoemulsion” is defined herein as having a mean droplet size of 100 nm or smaller; a “microemulsion” is defined herein as having a mean droplet size greater than 100 nm.

Colloidal particulate systems such as emulsions include a continuous phase and a dispersed phase (e.g., including droplets) therewithin. Kinetic stability in an emulsion can occur when the dispersed phase's droplet size distribution is narrow and its mean droplet size is smaller than about 300 nanometers. Because of their small size, Brownian motion of these droplets can overcome creaming or sedimentation processes that would otherwise cause them to eventually coalesce and segregate into a separate layer. Nanoemulsions are optically translucent, and progressively higher degrees of clarity, stability and interfacial area-to-volume ratio can be achieved as the droplet sizes are reduced. Emulsions of the present disclosure are kinetically stable, and therefore are suitable for incorporation into beverages.

In some embodiments, the cannabinoid emulsions are water-compatible (e.g., water soluble, water miscible, etc.), and can therefore readily be mixed or otherwise incorporated into beverages, at a variety of desired concentrations, and in a homogenous or uniform manner throughout the beverage process. An important consideration/factor in cannabinoid consumption is bioavailability, defined by the American Heritage Medical Dictionary as the degree to which a drug or other substance becomes available to the target tissue after administration. Bioavailability can represent, or can be a proxy or substitute measurement for, the potency of the cannabinoid product. Cannabinoid nanoemulsions as set forth herein exhibit and facilitate exceptionally high bioavailability, with corresponding potency and faster onset of action/effect at the same or lower doses, as compared with known cannabinoid consumables.

The cannabinoid(s) (e.g., THC or CBD) in these cannabinoid emulsions can be in any concentration. In some embodiments, the THC or CBD concentration is 1-50 milligrams THC/milliliter emulsion (“mg/ml”), e.g., 2, 3, 4, 5, 6, 7, 8, 9, 10, 13, 15, 20, 25, 30, 35, 40 or 45 mg/ml. In various embodiments, the concentration is be chosen based on the usage contemplated. For example, in a beverage, 0.5 ml of a 10 mg/ml emulsion can be conveniently added to the beverage to make a beverage having 5 mg of cannabinoid. When producing a solid food product that provides a quantity of cannabinoid in a smaller volume product (e.g., a gummy with 5 mg cannabinoid in a 0.5 oz product) a cannabinoid emulsion having a higher concentration of cannabinoid, e.g., 25 mg/ml, can be more convenient than the more dilute 10 mg/ml emulsion, if the lower concentration emulsion has more water than the food recipe calls for.

### Cannabinoid Emulsion Preparation

Example emulsion-based cannabinoid preparations are set forth below, with reference to various types of equipment, including (but not limited to): centrifuges, particle filter devices, evaporators, distillation systems, chromatographs/potency analyzers, vacuum ovens, stirrers, ultrasonicator, and microfluidizers. Example centrifuges compatible with processes set forth herein include the Vertical Basket Centrifuge by Cannabis Centrifuge and the Basket Centrifuge by Delta Separations. Example filter devices compatible with processes set forth herein include the Bel-Art Polyethylene 24″ Table Top Buchner Funnel, the JoanLab Laboratory Filtration Apparatus (including a 2,000 milliliter (mL) flask, an aluminum clamp, and a 300 mL graduated funnel, designed for filtering particles, bacteria and other substances), and the Hochstrom Filter by Summit Research. Example evaporators compatible with processes set forth herein include the Heidolph Hei-VAP Industrial 20-Liter Rotary Evaporator, and the Buchiglas 20-Liter Industrial Rotary Evaporator. Example distillation units compatible with processes set forth herein include the Standard KDL6 Distillation Unit by Helderpad, and the Shortpath Distillation 5-Liter Setup by Lab Society. Example chromatographs compatible with processes set forth herein include the Low-Pressure Chromatography Column by Axi Chrom, the Industrial Centrifugal Partition Chromatography Unit by Rotachrom, the Agilent 1100 High Performance Liquid Chromatograph (HPLC) System, and the Shimadzu Cannabis Potency Analyzer. Example vacuum ovens compatible with processes set forth herein include the Across International Elite 4.4 five-sided Heating Drying Vacuum Oven. Example stirrers compatible with processes set forth herein include the Chemglass Digital Overhead Stirrer, CAFRAMO, and the Fisherbrand Over Head Stirrer. An example ultrasonicator compatible with processes set forth herein is the BSP-1200 Ultra Sonication System by Sonomechanics. An example microfluidizer compatible with processes set forth herein is the Biopharmaceutical & Current Good Manufacturing Practice (CGMP) Microfluidizer by Microfluidics.

In some embodiments, a cannabinoid nanoemulsion is prepared by a method comprising:

freezing a portion of a Cannabis plant to produce frozen Cannabis, wherein the Cannabis plant comprises at least one cannabinoid;

submerging the frozen Cannabis in at least 95% ethanol to produce a mixture;

storing the mixture for a duration sufficient to convert the ethanol into an ethanol-cannabinoid solution;

removing the ethanol-cannabinoid solution from the mixture;

concentrating the ethanol-cannabinoid solution using an evaporator, to produce a concentrated ethanol-cannabinoid solution;

distilling the concentrated ethanol-cannabinoid solution to an ethanol concentration of between about 5% and about 10%, to produce a cannabinoid concentrate;

heating the cannabinoid concentrate sufficient to decarboxylate the cannabinoid concentrate;

performing a distillation of the cannabinoid concentrate;

adding an oil comprising C14 triglycerides to the distilled cannabinoid concentrate; and

processing the cannabinoid concentrate to form a cannabinoid emulsion.

In these embodiments, the freezing can be performed in any manner, e.g., using a freezer, ice, dry ice, liquid nitrogen, etc.

The formation of the emulsion from the distilled cannabinoid concentrate can be by any method now known or later discovered. In some embodiments, the emulsion formation is by microfluidizing and/or ultrasonicating.

In some of these embodiments, the at least 95% ethanol is nondenatured absolute (100%) ethanol.

The distillation can be by any manner known in the art, e.g., using a distillation apparatus in atmospheric pressure, a low pressure distillation apparatus, or at very low pressure (molecular distillation), using an appropriate molecular distillation apparatus, as known in the art. The distillation can be performed once or multiple times. For example, one or more of the cannabinoid-rich fractions (e.g., a high-THC resin) can be distilled three times at this step. The cannabinoid-rich fractions can be selected, for example, based on transparency/color (e.g., the clearest isolate(s) can be selected) and/or odor (e.g., the isolate(s) having the least odor can be selected).

Any oil or mixture having C14 triglycerides can be utilized in these methods. Examples include long chain triglycerides (LCT) or mixtures of medium chain triglycerides (MCT) and LCT, as they are known in the art. In various embodiments, the oil is coconut oil, for example refined coconut oil.

The decarboxylation of acidic forms of naturally occurring cannabinoids greatly increases the bioavailability of the cannabinoids. Protocols for this process are known in the art. See, e.g., Iffland et al., 2016; Wang et al., 2016. Decarboxylation can be achieved by heating the concentrate to 98-200° C., for 4 hr. (98° C.) to seconds (200° C.). To avoid side reactions, heating below 157° C. is advised. In some embodiments, the concentrate is heated to about 145° C. for 7-15 min. In other embodiments, the concentrate is heated to about 130° C. for 15-30 min.

The following additions to this method provide for an emulsion product that is purer and/or has a less variable droplet size range.

In some embodiments, the method further comprises reducing the temperature of the ethanol-cannabinoid solution to between about −40° C. and about −80° C.; and removing a precipitate from the ethanol-cannabinoid solution prior to the concentrating of the ethanol-cannabinoid solution.

In other embodiments, the mixture is a first mixture, and the method further comprises

heating the ethanol-cannabinoid solution to a temperature of between about 50° C. and about 80° C.;

adding carbon to the heated ethanol-cannabinoid solution to produce a second mixture;

agitating the second mixture; and

filtering the carbon from the second mixture.

In further embodiments, the method further comprises separating cannabinoid compounds from the cannabinoid concentrate prior to forming the cannabinoid emulsion. This separation step can be by any method known in the art, e.g., any chromatography method such as liquid chromatography methods or high performance liquid chromatography. In some embodiments, the cannabinoid compounds are separated by column chromatography.

Any solid media known in the art can be used in this step, e.g., any gel such as silica, Sephadex or Sepharose, a reverse phase medium, etc. In some embodiments, the chromatography is silica column chromatography.

In other embodiments, the method further comprises homogenizing the cannabinoid concentrate after adding the oil and prior to emulsion formation. The homogenization can be performed by any means known in the art, for example by applying heat to achieve a temperature of between about 40° C. and about 70° C., and gently agitating (e.g., using a stirrer).

In various embodiments, an additive to the cannabinoid concentrate is added prior emulsion formation, e.g., after adding the oil, or prior to or during the homogenization step. Any useful additive can be added, e.g., compounds that can improve the results of the emulsion formation step, or to add a fragrance or flavor component to the nanoemulsion. In some embodiments, the additive is vitamin E, lecithin derived phospholipids, a preservative (e.g., a blend of preservatives, such as sorbic acid, citric acid and/or sodium benzoate), water, or any combination thereof.

The Cannabis plant can comprise any cannabinoid or combination of cannabinoids that are processed and, after decarboxylation, are incorporated into the nanoemulsion. In some embodiments, at least one cannabinoid is THC or tetrahydrocannabinolic acid. In other embodiments, at least one cannabinoid is CBD or cannabidiolic acid.

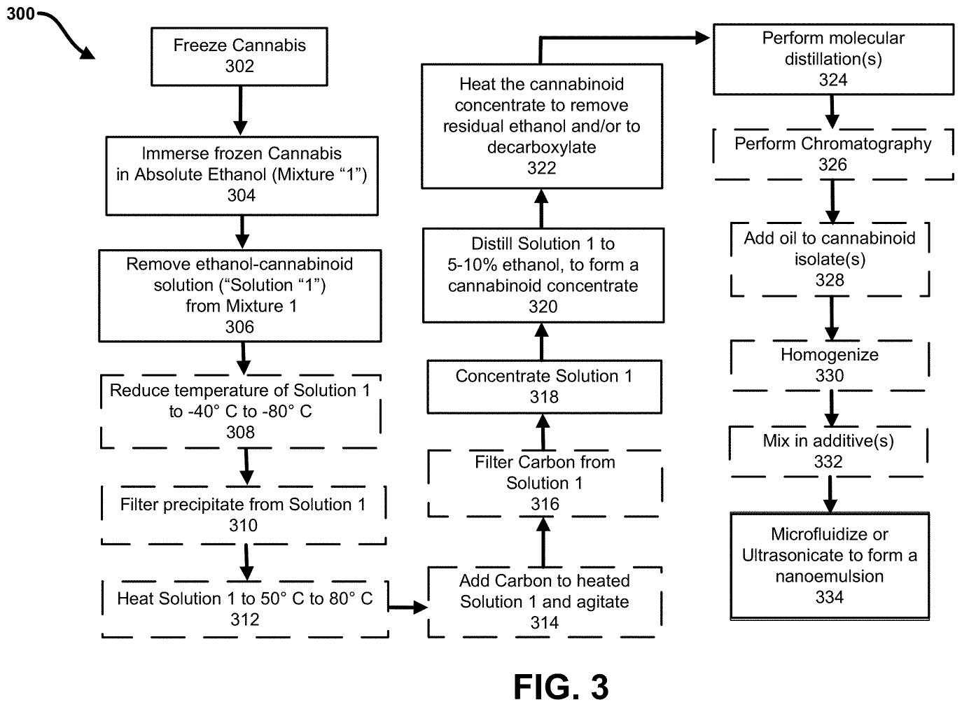

FIG. 3 is a diagram showing a method of preparing a cannabinoid nanoemulsion, according to some embodiments. As shown in FIG. 3, the method 300 begins with freezing Cannabis 302 and immersing the frozen Cannabis plant material in absolute ethanol 304 to form a first mixture (“Mixture 1”). After a predetermined dwell period, cannabinoids are extracted from the Cannabis plant material into the ethanol, and the ethanol-cannabinoid solution (“Solution 1”) is removed 306 from Mixture 1. The temperature of Solution 1 is optionally reduced to between about −40° C. and about −80° C. 308, followed by the removal of precipitate from Solution 1 310. Solution 1 is optionally then heated 312 to between about 50° C. and about 80° C. Carbon can be added to the heated Solution 1 and agitated 314, followed by a filtration of the carbon from Solution 1 316. Next, Solution 1 is concentrated (e.g., using an evaporator) 318 and distilled to an ethanol concentration of between about 5-10% 320 to form a cannabinoid concentrate. The cannabinoid concentrate is heated 322 to remove residual ethanol and/or to decarboxylate the cannabinoid concentrate, followed by one or more molecular distillations 324. Chromatography is optionally performed 326 e.g., to fractionate/separate cannabinoid isolates (however, other methods of segregating the cannabinoid isolates can be performed). Oil is added to the cannabinoid isolate(s) 328. The cannabinoid isolate(s) are optionally homogenized 330 and/or additive(s) are added to the cannabinoid isolate(s) 332. The cannabinoid isolate(s) are then microfluidized and/or ultrasonicated to form a nanoemulsion 334.

A further example method of preparing a cannabinoid nanoemulsion, according to some embodiments, is as follows:

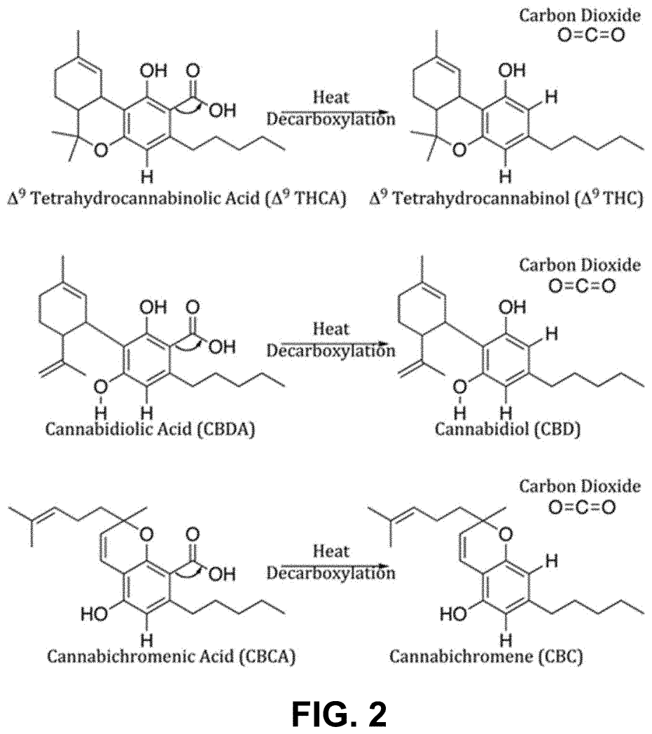

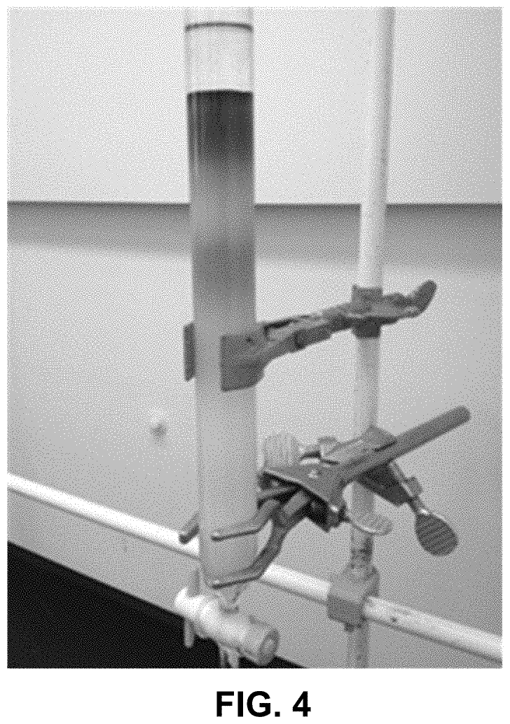

1. Freeze Cannabis biomass at a temperature within the range of between about −80° C. to about 0° C.;
2. Cool 200 proof non-denatured ethanol to a temperature of between about −80° C. to about 0° C.;
3. Soak the frozen Cannabis biomass with the cold ethanol for about 3-10 minutes to form an ethanol-cannabinoid solution;
4. After soaking is complete, use a centrifuge to capture the ethanol-cannabinoid solution;
5. Bring the ethanol-cannabinoid solution to a temperature of between about −80° C. and about −40° C.;
6. Filter out the precipitate using 30 to 1 micron (μm) filters;
7. Heat up the solution to a temperature of between about 50° C. and about 80° C. and add three grades (e.g., course, fine, and extra fine) of activated carbon;
8. Thoroughly agitate the solution with carbon while maintaining the temperature for 15-30 mins;
9. Filter out the carbon from the heated solution;
10. Prepare a slurry by combining silica and ethanol, at a ratio of about 1:1;
11. Pour the slurry into a column (e.g., a glass or stainless steel chromatography column) having a sub-micron filter in the bottom;
12. Use vacuum and/or positive pressure to pack the column (e.g., pack the silica tightly within the silica column);
13. Run the heated solution through the column matrix (e.g., silica matrix);
14. Concentrate the solution by evaporating the ethanol using a rotary evaporator;
15. Increase the temperature of the concentrated solution to a temperature of between about 40° C.−50° C.;
16. Gently apply vacuum to the silica column until a pressure of between about 150 Torr and about 30 Torr is reached (e.g., on a 20-liter rotary evaporator with a 6 cubic feet per minute (cfm) vacuum pump, it can take about 3-5 minutes to reach 150 Torr);
17. Begin distillation of the concentrated solution;
18. Once the ethanol concentration has reached between about 5-10%, pour the distilled, concentrated solution (“cannabinoid concentrate”) into a glass container;
19. Increase the temperature of the cannabinoid concentrate to about 100° C. in a vented hood to boil off the remainder of the ethanol;
20. Increase the temperature of the cannabinoid concentrate to about 130° C. to remove the carboxyl group from (i.e., decarboxylate) the acidic forms of cannabinoids (e.g., to convert CBDA and/or THCA to CBD and/or THC respectively). FIG. 2 illustrates the chemical reaction of decarboxylation, in which a carboxyl group is being removed from THCA, CBDA, and CBCA with the use of heat.
21. Transfer the decarboxylated concentrate to a distillation apparatus;
22. Perform molecular distillation to form a distillate then collect cannabinoid-rich fractions from the distillate.
23. (Optional) Dissolve the selected cannabinoid-rich fractions in 3-5 parts of a non-polar solvent such as pentane, hexane, and/or heptane;
24. (Optional) Pass the resulting solution through a silica column (e.g., a glass chromatography column) using a solvent gradient (e.g., beginning with 0.1% ethyl-acetate and gradually increasing to 10% ethyl-acetate). An example glass chromatography column is shown at FIG. 4. In FIG. 4, a crude resin has been loaded, and compounds of the distillate (also referred to herein as a “resin”) have been separated within the column based on their molecular weights. The stationary phase is silica, and the mobile phase is a solution including cannabinoid distillate in a non-polar solvent;
25. (Optional) Collect one or more fractions from the silica column and analyze the cannabinoid content in each fraction, for example using a high performance liquid chromatograph (HPLC) or a Centrifugal Partition Chromatograph (CPC) (e.g., by Rotachrom), to determine a cannabinoid purity;
26. (Optional) If, at step 25, it is determined that the cannabinoids have not been separated to achieve a cannabinoid purity of 99%, then repeat steps 18-21;
27. (Optional) If, at step 25, it is determined that a cannabinoid purity of 99% has been achieved, concentrate the fractions using an evaporator (e.g., a rotary evaporator), and dry the resulting cannabinoid isolate(s) completely (e.g., in a vacuum oven);
28. Add 5-10 parts (1 part=amount of cannabinoid present) purified/refined coconut oil to the cannabinoid isolate(s). The cannabinoid isolate(s) can be selected, for example, based on potency (e.g., having a target potency of about 99% or higher);
29. Homogenize the combined cannabinoid isolate(s) and purified/refined coconut oil;
30. While maintaining the temperature and agitation of step 29:

a. Add 2-4 parts vitamin E (e.g., derived from sunflower tocopherols)

b. Add 1-3 parts lecithin derived phospholipids

c. Add 0.4-1.0 parts preservative

d. Add 15-20 parts distilled water;

31. Agitate thoroughly whilst maintaining a temperature of between about 40° C. and about 70° C., to produce a pre-emulsion;
32. Pass the pre-emulsion through a microfluidizer or apply ultrasonication until the resulting solution becomes translucent (i.e., until a nanoemulsion has been formed);
33. Perform particle size analysis to measure the mean droplet size in the solution;
34. If the mean droplet size is below 75 nanometers (nm), proceed to the steps below. If the mean droplet size is larger than 75 nm then repeat steps 29, 31 and 32 until the mean droplet size is below 75 nm.
35. Pass the nanoemulsion through a filter (e.g., a 220 nm sterile hydrophilic filter); and
36. Measure the cannabinoid potency of the nanoemulsion (e.g., via a third party testing lab).

Using the procedure immediately above, a 10 mg/ml cannabinoid emulsion will be 80-90% water. In some embodiments, a higher concentration (e.g., 25 mg/ml) cannabinoid emulsion can be achieved by reducing the amount of distilled water added in step 30. Using that procedure, a 10 mg/ml cannabinoid nanoemulsion is a translucent liquid; a 25 mg/ml cannabinoid nanoemulsion is an opaque creamy white liquid.

The present invention is also directed to an emulsion made by any of the methods described above. The droplets in the emulsion can have any average (mean) size of 400 nm or smaller, for example 300, 200, 150, 125, 100, 75, 70, 65, 60, 55, 50, 45, 40, 35, 30, 25, 20, 15, 10 nm, or any size in between.

There is an inverse relationship between the size of the emulsion droplet and the bioavailability of the cannabinoid therein. The nanoemulsion preparations, when ingested, e.g., in a pill, food or beverage, cause an effect (e.g., psychotropic, pain relieving, seizure reducing, anxiety reducing, sleep inducing, etc.) of a cannabinoid therein to be faster than the same amount of the cannabinoid that is not in the nanoemulsion. In various embodiments, the effect is 25, 30, 35, 40, 45, 50, 55, 60, 65, 70, 75, 80, 85, 90, 95, or 99%, or any percentage in between, faster when the nanoemulsion is ingested than when the cannabinoid is not in the nanoemulsion.

Additionally, an effect of a cannabinoid requires a smaller amount of cannabinoid when in the nanoemulsion than when not in the nanoemulsion. In various embodiments, the effect requires at least 50%, twice as much, 3, 4, 5, 6, 7, 8, 9 or 10 times as much, or any amount in between, when the cannabinoid is not in the nanoemulsion.

In some embodiments, when incorporated into a food or beverage, an effect of a cannabinoid in the nanoemulsion is at least 50% faster than the same amount of the cannabinoid in the food or beverage that is not in the nanoemulsion.

In other embodiments, when incorporated into a food or beverage, an effect of a cannabinoid in the nanoemulsion is at least 80% faster than the same amount of the cannabinoid in the food or beverage that is not in the nanoemulsion.

In additional embodiments, when incorporated into a food or beverage, an effect of a cannabinoid in the nanoemulsion is at least 80% faster than at least twice as much of the cannabinoid in the food or beverage that is not in the nanoemulsion.

In further embodiments, an effect of a cannabinoid in the nanoemulsion is achieved with less than 20% of the quantity of the cannabinoid in the food or beverage that is not in the nanoemulsion.

The faster onset and offset of effects of the ingested nanoemulsions with smaller amounts of cannabinoids provide unique characteristics of beverages and foods comprising the cannabinoid nanoemulsions.

### Cannabinoid Nanoemulsion/Microemulsions

As discussed above, there is an inverse relationship between the size of the emulsion droplet and the bioavailability of the cannabinoid therein. As the droplet size of the emulsion decreases below about 150 nm, the onset (start of the cannabinoid effect) time and offset (end of the cannabinoid effect) time are shorter, and a smaller amount of cannabinoid is required to have the same effect. A mixture of a cannabinoid nanoemulsion and microemulsion (a cannabinoid “nanoemulsion/microemulsion”) would therefore have the short onset time of the nanoemulsion and the longer offset time of a larger microemulsion. By adjusting the relative amount of nanoemulsion and microemulsion in the nanoemulsion/microemulsion, a nanoemulsion/microemulsion can be designed that can have any onset and offset time desired.

Thus, in some embodiments, the cannabinoid emulsions discussed herein are nanoemulsion/microemulsions. A nanoemulsion having any droplet size of 100 nm or less, and a microemulsion having any droplet size greater than 100 nm, can be utilized to make the nanoemulsion/microemulsion. In some embodiments, the nanoemulsion component has a mean droplet size of 15-75 nm the and the microemulsion component has a mean droplet size of 100-400 nm. In other embodiments, the nanoemulsion component has a mean droplet size of 25 nm-50 nm the and the microemulsion component has a mean droplet size of the of 150-300 nm.

In some embodiments, more than one nanoemulsion and/or more than one microemulsion can be utilized in these nanoemulsion/microemulsions.

A mixture of different sized nanoemulsions without a microemulsion, and a mixture of different sized microemulsions without a nanoemulsion, are also envisioned herein.

### Cannabinoid Emulsion-Infused Beverages

Also provided herewith are beverages comprising the above cannabinoid emulsions. Beverages set forth herein can include and/or are infused with cannabinoid emulsions (also referred to herein as “emulsified cannabinoids”) and provide increased bioavailability (as compared with known cannabinoid consumables/edibles and dosing methods) of one or more cannabinoids to a user when consumed. Beverages of the present disclosure can provide rapid onset effects and/or rapid offset effects, while potentially avoiding health risks and/or unpredictable effects of known cannabinoid consumables. In some embodiments, fast-onset cannabinoid-infused beverages are prepared by preparing the above-described cannabinoid nanoemulsions and dispersing the nanoemulsions in a beverage, such as beer or other malt beverage. Cannabinoid-infused beverages of the present disclosure can be used as an alternative to other consumable/ingestible cannabinoid products, without the negative side effects of, for example, smoking or inhalation-based dosing. Cannabinoid-infused beverages of the present disclosure can also be used as a beneficial alternative to known alcoholic beverages. The CDC has reported that nearly 88,000 alcohol-related deaths occur each year, in stark contrast with zero deaths caused by marijuana.

The nanoemulsions in these beverages can be of any average (mean) droplet size of 100 nm or smaller, as previously described. In some embodiments, the mean droplet size is 75 nm or smaller. In other embodiments, the mean droplet size is 50 nm or smaller. In additional embodiments, the mean droplet size is 15 nm or smaller.

As previously described, the nanoemulsions provided herewith, in these beverages, provide faster onset and offset of a cannabinoid effect, with less cannabinoid, than beverages with cannabinoids not in the nanoemulsion. In some embodiments, an effect of a cannabinoid therein is at least 50% faster than the same amount of cannabinoid not in the nanoemulsion in the beverage. In other embodiments, an effect of a cannabinoid therein is at least 80% faster than the same amount of cannabinoid not in the nanoemulsion in the beverage. In additional embodiments, an effect of a cannabinoid therein is at least 80% faster than at least twice as much cannabinoid not in the nanoemulsion in the beverage. In further embodiments, an effect of a cannabinoid therein is achieved with less than 20% of the quantity of the cannabinoid in the food or beverage that is not in the nanoemulsion.

Any dose of any cannabinoid can be provided in the beverage. For example, a serving size of the beverage (e.g., 6-12 oz) can have 20, 19, 18, 17, 16, 15, 14, 13, 12, 11, 10, 9, 8, 7, 6, 5, 4, 3, 2, or 1 mg, or any amount within or outside those dosages, of any cannabinoid, including but not limited to THC and CBD, alone or in any mixture of cannabinoids. In some embodiments, the beverage comprises THC at a dosage of 5 mg or less per 6-12 oz serving.

Any beverage, now known or later developed, can be infused with the cannabinoid nanoemulsions. In some embodiments, the beverage is beer or wine. In some of those embodiments, the beer or wine is de-alcoholized. In other embodiments, the beverage is carbonated. In additional embodiments, the beverage is a coffee drink, a tea drink (teas made from leaves of the tea plant Camellia sinensis as well as “herbal” teas made from parts of other plant species are envisioned herein), an alcoholic beverage, water, a sparkling water or any other carbonated beverage.

The cannabinoid emulsions of the present invention can also be infused into liquids that are not beverages, e.g., medicinal products (e.g., cough syrup, ear drops, nose drops, eye drops), liquid soaps, emollients, lotions, shampoos, conditioners, cream cosmetics, etc.

Also provided are methods of preparing beverages infused with cannabinoid emulsions. In some embodiments, those methods comprise

de-alcoholizing beer to form a non-alcohol cereal beverage;

rectifying the non-alcohol cereal beverage by adding a cannabinoid nanoemulsion, e.g., any of the nanoemulsions described above, to the non-alcoholic cereal beverage; and

homogenizing the cannabinoid-infused cereal beverage.

In some embodiments, the method further comprises carbonating the cannabinoid-infused cereal beverage to a desired carbonation level.

As used herein, to “rectify” is to convert a product into a new and different product.

In some of these embodiments, the carbonating comprises introducing CO₂ to the cannabinoid-infused cereal beverage using a carbonation stone.

Any cannabinoid emulsion described above can be utilized in these methods. In some embodiments, the cannabinoid emulsion is a nanoemulsion. In other embodiments, the cannabinoid emulsion is a microemulsion. In additional embodiments, the cannabinoid emulsion is a cannabinoid nanoemulsion/microemulsion.

These methods can further comprise quality control measures, for example analyzing the cannabinoid-infused cereal beverage to determine the quantity of a cannabinoid in the cannabinoid-infused cereal beverage, or analyzing the cannabinoid-infused cereal beverage to determine onset time, offset time, and/or potency of an effect of a cannabinoid in the beverage.

Once the nanoemulsion has been prepared, an appropriate amount of the nanoemulsion can be measured/segregated for a desired batch of a desired product (e.g., a beverage) and infused into the product to form an infusion. The infusion can then be homogenized.

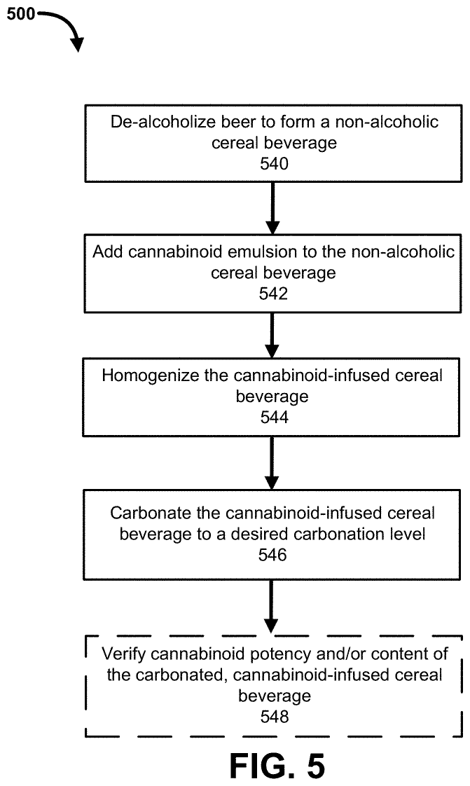

An exemplary method of brewing a cannabinoid-infused cereal beverage, according to some embodiments, is shown in FIG. 5. As shown in FIG. 5, the method 500 includes de-alcoholizing beer 540, to form a non-alcohol cereal beverage. The dealcoholizing can be performed by any means known in the art. See, e.g., Lipnizki, 2014; Kosseva, 2017. In some embodiments, the dealcoholization is by low temperature vacuum technology. A cannabinoid nanoemulsion, e.g., as described above, is added to the non-alcoholic cereal beverage 542. The cannabinoid-infused cereal beverage is homogenized 544 and, using carbon dioxide (CO₂) and a carbonation stone, carbonated 546 to a desired carbonation level.

A further nonlimiting example method of brewing a cannabinoid-infused cereal beverage, followed by example supply chain events, according to some embodiments, is as follows:

1. Combine water, malted barley, other malted and/or unmalted grains, and minerals in a mash mixer to form a mash;
2. Heat the mash to a temperature of between about 159° F. to about 164° F. and maintain at the temperature for about 30-60 minutes;
3. Increase the temperature of the mash to between about 165° F. and about 170° F. to stop or slow the conversion of carbohydrates into fermentable sugars;
4. Transfer the mash to a lauter tun or other separator;
5. Perform a vorlauf (recirculation) process by recirculating liquid of the mash (wort) from the bottom of the mash through false-bottom screens and back over the top of the mash to filter out most of the grain particulate. The vorlauf process can be performed for between about 10 minutes and about 30 minutes;
6. Transfer the wort from the lauter tun to a boil kettle;
7. After 10-20% of the wort has been transferred to the boil kettle, add hops to the boil kettle;
8. Perform sparging by sprinkling hot water (e.g., at a temperature between about 160° F. and about 165° F.) over the mash within the lauter tun while transferring the wort, to create more wort;
9. Once sparging has begun, add minerals (e.g., one or more of: sodium chloride, calcium chloride, calcium carbonate, calcium sulfate, and/or the like);
10. When the transfer of the wort to the boil kettle has been completed, bring the wort to a boil, and boil the wort for about 60-90 minutes;
11. Add hops and/or maltodextrin to the boiling wort;
12. When the boiling has completed, add ambient temperature water to the boil kettle to increase the volume of and decrease the temperature of the wort;
13. Transfer the wort to a whirlpool vessel through a tangential inlet port to settle solids (trub) to the bottom of the whirlpool vessel;
14. Add hops and/or other flavor additive(s) (e.g., fruit, spices, herbs, tea, coffee, sweetener, sugar, etc.) to the wort in the whirlpool vessel;
15. Allow the trub to settle for about 15-30 minutes;
16. Decant the wort off of the trub, and chill the wort (e.g., using a heat exchanger, such as a Goodnature HTST plate heat exchanger processor) to bring the wort to a fermentation temperature (e.g., about 48° F. to about 75° F.) and send the wort into a fermentation vessel;
17. Add brewer's yeast and a gluten-reducing/clarity-enhancing enzyme (e.g., an enzyme containing proline-specific endo-protease derived from a selected strain of Aspergillus niger) to the wort in the fermentation vessel (FV) to form a mixture;
18. Ferment the mixture for 1-3 weeks at a temperature of about 48° F. to about 75° F., to produce beer;
19. Monitor the fermentation (e.g., daily) to determine a degree of completeness of the fermentation;
20. When the fermentation is determined to be ⅔-¾ complete, increase the temperature of the beer by about 1° F.-13° F.;
21. Once the fermentation is determined to be complete (e.g., based on observing the same gravity reading 2 days in a row), perform a diacetyl test, as follows:

a. Diacetyl Test

1. Pull a sample of the beer from the fermentation vessel;

2. Heat the sample to about 180° F.-200° F., for about 15 minutes;

3. Chill the sample to about 40° F.-50° F.; and

4. Smell and taste the sample to assess the diacetyl.

22. If the sample is determined to be free or substantially free of diacetyl, lower the temperature of the beer in the fermentation vessel by about 2° F.-20° F. If diacetyl is detected, wait 18-36 hours and repeat step 21;
23. Lower the temperature of the beer by about 2° F.-20° F. regularly (e.g., daily) until the beer has reached a temperature of about 32° F.-52° F.;
24. Remove yeast from the bottom of the fermentation vessel;
25. Add hops and/or other flavor additive(s) (e.g., fruit, spices, herbs, tea, coffee, etc.) to the beer in the fermentation vessel;
26. 12-36 hours later, re-suspend the hops and/or other flavor additive(s) in the fermentation vessel by blowing CO₂ up through the bottom of the fermentation vessel;
27. Lower the temperature of the beer in the fermentation vessel to a temperature of about 32° F.-35° F.;
28. After 5-10 days at 32° F.-35° F., add a clarifying agent to the beer and mix by blowing CO₂ into the fermentation vessel (e.g., through an up-turned racking arm). The clarifying agent can include, for example, a brewing enzyme such as Brewers Clarex®;
29. Allow the beer in the fermentation vessel to clarify for about 5-10 days;
30. Remove hops and yeast from the beer by racking beer from the fermentation vesselracking arm off trub and sending it to the brite beer tank (BBT) through a centrifuge;
31. Hold the beer in the BBT, at a temperature of about 32° F.-40° F.;
32. Gently remove the alcohol from the beer by vacuum at low temperature, capture volatized/volatilized aroma and infuse it back into a non-alcoholic beer (a cereal beverage) by racking beer out of the fermentation vessel racking arm off trub and through a de-alcoholizer machine into a receiving tank (e.g., a fermentation vessel) that includes a non-alcoholic, beverage-specific clean-in-place (CIP) system;

a. Exemplary Non-Alcoholic Beverage-Specific CIP

1. Recirculate a ˜140° F.-160° F., 1.5-2.5% caustic solution through the CIP for 20-45 minutes;

2. Pump the caustic solution out of the CIP into a holding vessel;

3. Rinse the CIP with ˜140° F.-160° F. water for about 20 minutes;

4. Recirculate a ˜100° F.-140° F., 1.5-2.5% phosphoric/nitric acid blend solution through the CIP for about 10-30 minutes;

5. Pump the phosphoric/nitric acid solution out of the CIP into a holding vessel;

6. Rinse the CIP for about 10-20 minutes with ambient temperature, reverse osmosis (R/O) water;

7. Test the conductivity of the rinse water to ensure that the chemicals have been thoroughly rinsed. Sufficient rinsing can be associated with a conductivity of between 0 μS/cm and about 100 μS/cm;

8. If the conductivity is found to be within range, continue with the steps that follow. If not, repeat steps 6 and 7;

9. Perform a liquid Adenosine Triphosphate (ATP) test on the rinse water. The rinse water can be determined to be “within range” if the measured value is between 0 and 10 relative light units (RLU);

10. If the liquid ATP test is within range, continue with the steps that follow. If not, repeat steps 6-9;

11. Perform an ATP swab test on a surface of the CIP that non-alcoholic beverage will touch. The surface can be determined to be “within range” if the measured value is between 0 and 10 RLU;

12. If the ATP swab test is in range, continue with the steps that follow. If not, repeat steps 6-11;

13. Recirculate a 150-250 ppm peracetic acid sanitizer solution through the CIP for about 5 minutes;

14. Pump peracetic acid sanitizer solution out of the CIP into a holding vessel; and

15. Purge the CIP of oxygen by flowing CO₂ through the CIP.

33. Hold the cereal beverage in the fermentation vessel at a temperature of about 35° F.-40° F.;
34. Add hops and/or other flavor additive(s) (e.g., fruit, spices, herbs, tea, coffee, sweetener, etc.) to the cereal beverage in the fermentation vessel;
35. 12-36 hours later, re-suspend the hops and/or other flavor additive(s) in the fermentation vessel by blowing CO₂ up through the bottom of the fermentation vessel;
36. Let the hops and/or other flavor additive(s) settle for 1-5 days;
37. Rack the cereal beverage out of the fermentation vessel racking arm off trub and into a moveable transfer vessel that has received a non-alcoholic beverage-specific CIP;
38. Test the cereal beverage (e.g., using a third-party lab) to verify alcohol content and microbial stability, e.g., in accordance with a safety plan;
39. Sell and ship the cereal beverage in a moveable transfer vessel to a Cannabis facility. Keep the cereal beverage at a temperature of about 35° F.-40° F. during shipment;
40. Transfer the cereal beverage through a flash pasteurizer that has received a non-alcoholic beverage-specific CIP, into a BBT that has received a non-alcoholic beverage-specific CIP.

a. The pasteurizer holds a temperature of about 165° F.-205° F. for about 15-30 seconds;

41. Hold the cereal beverage in the BBT at a temperature of about 35° F.-40° F.;
42. Add a distilled hop oil/ethanol mixture and/or other distilled flavor additive(s) to the cereal beverage in the BBT.

a. To make a distilled hop oil/ethanol mixture, take one part hop oil and 1-5 parts ethanol and mix together in a small jar. Thoroughly agitate the mixture by shaking for about 30-300 seconds, and leave the mixture in a cold box at a temperature of about 40° F.-50° F. overnight;

43. Add cannabinoid emulsion to the cereal beverage in the BBT to form a cannabinoid-infused cereal beverage, and push CO₂ in through a carbonation stone to homogenize and carbonate the cannabinoid-infused cereal beverage;
44. Carbonate the cannabinoid-infused cereal beverage to a carbonation level of about 2.5-2.8 volumes of CO₂ (i.e., such that each cubic inch of the cannabinoid-infused cereal beverage includes about 2.5-2.8 cubic inches of CO₂ dissolved therein);
45. Verify the cannabinoid potency and/or content of the cannabinoid-infused cereal beverage, e.g., using high-performance liquid chromatography;
46. Package the cannabinoid-infused cereal beverage in kegs (e.g., using a keg filler), cans (e.g., using a can filler), or bottles (e.g., using a bottle filler). The packaging equipment is preferably cleaned, according to a non-alcoholic beverage-specific CIP, prior to use; and
47. Test the final product (e.g., using a third-party lab) to verify cannabinoid content and/or microbial stability, e.g., in accordance with a safety plan, prior to releasing the product for sale.

An example method of brewing a CBD-infused beer, according to some embodiments, is as follows:

1. Combine water, malted barley, optionally other malted and/or unmalted grains, and minerals in a mash mixer to form a mash, at carbohydrate conversion temperatures (e.g., about 144° F.-158° F.);
2. Hold the mash at the carbohydrate conversion temperature for about 30-60 minutes;
3. Increase the temperature of the mash to about 165° F.-170° F. to stop or slow the conversion, within the mash, of carbohydrates to fermentable sugars;
4. Transfer the mash to a lauter tun;
5. Perform a vorlauf (recirculation) process by recirculating liquid of the mash (wort) from the bottom of the mash through false-bottom screens and back over the top of the mash to filter out most of the grain particulate. The vorlauf process can be performed for between about 10 minutes and about 30 minutes;
6. Transfer the wort from the lauter tun to a boil kettle;
7. After 10-20% of the wort has been transferred to the boil kettle, add hops to the boil kettle;
8. Perform sparging by sprinkling hot water (e.g., at a temperature between about 160° F. and about 165° F.) over the mash within the lauter tun while transferring the wort, to create more wort;
9. Once sparging has begun, add minerals (e.g., one or more of: sodium chloride, calcium chloride, calcium carbonate and calcium sulfate);
10. When the transfer of the wort to the boil kettle has been completed, bring the wort to a boil, and boil the wort for about 60-90 minutes;
11. Add hops to the boiling wort;
12. When the boiling has completed, add ambient temperature water to the boil kettle to increase the volume of and decrease the temperature of the wort;
13. Transfer the wort to a whirlpool vessel (e.g., through a tangential inlet port) to settle the solids (trub) to the bottom;
14. Add hops and/or other flavor additive(s) (e.g., fruit, spices, herbs, tea, coffee, sweetener, sugar, etc.) to the wort in the whirlpool vessel;
15. Allow the trub to settle for about 15-30 minutes;
16. Decant the wort off of the trub, and chill the wort (e.g., using a heat exchanger, such as a Goodnature HTST plate heat exchanger processor) to bring the wort to a fermentation temperature (about 48° F.-75° F.) and send/transport the wort to a fermentation vessel;
17. Add brewer's yeast, a gluten-reducing/clarity-enhancing enzyme (e.g., an enzyme containing proline-specific endo-protease derived from a selected strain of Aspergillus niger) to the wort in the fermentation vessel to form a mixture;
18. Ferment the mixture for 1-3 weeks while maintaining the temperature at about 48° F.-75° F. to produce beer;
19. Monitor the fermentation process regularly (e.g., daily) to determine a degree of completeness of the fermentation;
20. When the fermentation is determined to be ⅔-¾ complete, increase the temperature of the beer by about 1° F.-13° F.;
21. Once the fermentation is determined to be complete (e.g., based on observing the same gravity reading 2 days in a row), perform a diacetyl test (as discussed above).
22. If the sample is determined to be free or substantially free of diacetyl, lower the temperature of the beer in the fermentation vessel by about 2° F.-20° F. If diacetyl is detected, wait 18-36 hours and repeat step 21;
23. Lower the temperature of the beer by about 2° F.-20° F. regularly (e.g., daily) until the beer has reached a temperature of about 32° F.-52° F.;
24. Remove yeast from the bottom of the fermentation vessel;
25. Add hops and/or other flavor additive(s) (e.g., fruit, spices, herbs, tea, coffee, etc.) to the beer in the fermentation vessel;
26. 12-36 hours later, re-suspend the hops and/or other flavor additive(s) in the fermentation vessel by blowing CO₂ up through the bottom of the fermentation vessel;
27. Lower the temperature of the beer in the fermentation vessel to a temperature of about 32° F.-35° F.;
28. After 5-10 days at 32° F.-35° F., add a clarifying agent to the beer and mix by blowing CO₂ into the fermentation vessel (e.g., through an up-turned racking arm). The clarifying agent can include, for example, a brewing enzyme such as Brewers Clarex®;
29. Allow the beer in the fermentation vessel to clarify for about 5-10 days;
30. Remove hops, other flavor additive(s) and yeast from beer by racking beer from the fermentation vessel racking arm off trub and sending it to the BBT through a centrifuge;
31. Hold the beer in the BBT at 32° F.-40° F.;
32. Add CBD emulsion to the beer in the BBT to form a CBD-infused beer, and push CO₂ in through a carbonation stone to homogenize and carbonate the CBD-infused beer;
33. Carbonate the CBD-infused beer to a carbonization level of about 2.5-2.8 volumes of CO₂;
34. Verify the CBD potency and/or content of the CBD-infused beer, e.g., using HPLC;
35. Package the CBD-infused beer in kegs (e.g., using a keg filler), cans (e.g., using a can filler), or bottles (e.g., using a bottle filler); and
36. Test the final product (e.g., using a third party lab) prior to releasing the final product for sale.

### Beverage Production System and Apparatus

In some embodiments, a beverage production line includes a heat exchanger processor (e.g., a Goodnature HTST plate heat exchanger processor), one or more cleanable holding tanks (e.g., non-aseptic tanks), and a non-aseptic can filler.

### Sample Ready to Drink (RTD) Beverage Formula

An example ready-to-drink beverage formulation, according to some embodiments, is shown in Table 1 below:

TABLE 1
Example ready-to-drink beverage formulation

| Ingredient | Wt % |
|---|---|
| Water | ~80-90 |
| Sugar | ~5-10 |
| Citric Acid | ~0.04-0.05 |
| Flavor #1 | ~1-5 |
| Fruit or Tea Concentrate | ~0.5-0.9 |
| Cannabis Nanoemulsion | ~1-2 |
| Flavor #2 | ~1-2 |
| Total | 100.000 |

### Raw Material and Ingredient Quality Check

For quality assurance (QA) purposes, records can be maintained (e.g., electronically and/or in an automated manner) for all ingredients and batches, to capture data such as batching weights, lot numbers, dates of expiration, etc. An example batching process, according to some embodiments, is as follows:

1. Weigh sugar and citric acid, and set aside;

2. Weigh flavors, Cannabis emulsion and concentrates (e.g., shaking container(s) well prior to weighing and/or keeping refrigerated until mixing the beverage), and set aside;

3. Add water, sugar and citric acid to a brite tank and mix until the solids are fully dissolved, to form a solution;
4. Add flavors, Cannabis nanoemulsion, and concentrates to the solution and mix until uniform;
5. Pull/extract a 20-gram sample to test pH and Brix. In some embodiments, pH<3.9 (e.g., 3.25) is acceptable/desirable. pH levels on all completed batches and/or on randomly selected samples of finished products can be measured and tracked (e.g., in a pH log), for example according to a predefined schedule; and
6. If a measured pH level is found to be above the acceptable/desirable range, the pH can be reduced to a correct level (e.g., through the addition of citric acid), with optional follow-on testing and re-balancing. If a measured pH level is found to be below the acceptable/desirable range, the pH can be raised to a correct level (e.g., through the addition of sodium bicarbonate and/or potassium bicarbonate), with optional follow-on testing and re-balancing.

Details of an example pasteurization process, according to some embodiments, are as follows:

1. A pasteurizer includes a High Temperature/Short Time (HTST) Processing System (e.g., plate pasteurizer). The pasteurizer can be designed to process at a maximum flow rate of 4.4 gallons/min, which provides a residence time of 15 seconds in the holding tube.
2. The pasteurizer includes a temperature controller located at an exit of a last heating section/entrance of a holding tube thereof. The positioning of the temperature controller at this location effectively provides feedback data to the system to ensure that the proper sterilization temperature is maintained at the exit of the holding tube.
3. The holding tube includes a spiral section of piping following the last heating section of the plate heat exchanger. A resistance thermal device is positioned at the exit of the holding tube. The output of the resistance thermal device can be collected/charted on a paper chart recorder.
4. An analog temperature sensor is also positioned at the exit of the holding tube. The pasteurizer uses a product-to-product regeneration section, in which the hot sterile product is used as a heating medium for incoming raw product. The pasteurizer is equipped with adequate pressure sensors in the regeneration section, to ensure that the sterile product side is maintained at a pressure of at least 5 psi higher than that of the raw product side.
5. Following the regeneration section, the pasteurizer provides further cooling of the sterile product by using city water. A centrifugal-style pump can be used to modulate the flow of product through the pasteurizer.
6. Following pasteurization, the beverages are pumped into one of multiple (e.g., 3) product holding tanks, which can be located outdoors.
7. A pasteurization time log, including data verification and downloads by quality assurance staff, can be maintained. Data on the pasteurization time and temperature can be periodically (e.g., according to a predefined schedule) collected and stored, and target and acceptable ranges thereof can be specified for a given application.
8. If the pasteurization time and/or temperature is found to deviate outside the specification range, e.g., based on a sensor reading, an evaluation, verification, and storage of the deviation can be performed. A determination can be made as to whether the batch associated with the deviation should be quarantined, disposed of, or re-pasteurized, and/or if production should be halted.

Also provided herewith are methods of preparing a carbonated beverage infused with cannabinoid emulsions. The method comprises

providing a beverage;

adjusting a pH of the beverage to a predetermined pH value;

infusing the pH-adjusted beverage with a cannabinoid nanoemulsion, e.g., a cannabinoid nanoemulsion described above; and

carbonating the infused beverage to a desired CO₂ volume, to produce a cannabinoid-infused carbonated beverage.

These methods are not narrowly limited to any particular predetermined pH value. In some embodiments, the predetermined pH value is in a range of between about 4 and about 5. In some of those embodiments, the predetermined pH value is about 4.6.

Any cannabinoid emulsion described above can be utilized in these methods. In some embodiments, the cannabinoid emulsion is a nanoemulsion. In other embodiments, the cannabinoid emulsion is a microemulsion. In additional embodiments, the cannabinoid emulsion is a cannabinoid nanoemulsion/microemulsion.

Any cannabinoid, at any dose, can be in the emulsion infused into the beverage, as previously discussed. In some embodiments, the cannabinoid emulsion comprises THC and/or CBD.

In some embodiments, the above methods of making a beverage further comprise adding an oil emulsion, e.g., a medium chain triglyceride (MCT) emulsion. It has been discovered that adding an oil emulsion to a metallic (e.g., aluminum) can that has a liner (as all such metallic cans do) greatly reduces the loss of available cannabinoid in the beverage. Thus, adding the oil emulsion makes the cannabinoid nanoemulsion available for ingestion in the beverage for a longer time than if the oil emulsion was not added. In some embodiments, the measurable cannabinoid in the beverage decreases by less than 10% after 1 month of refrigerated or room temperature storage.

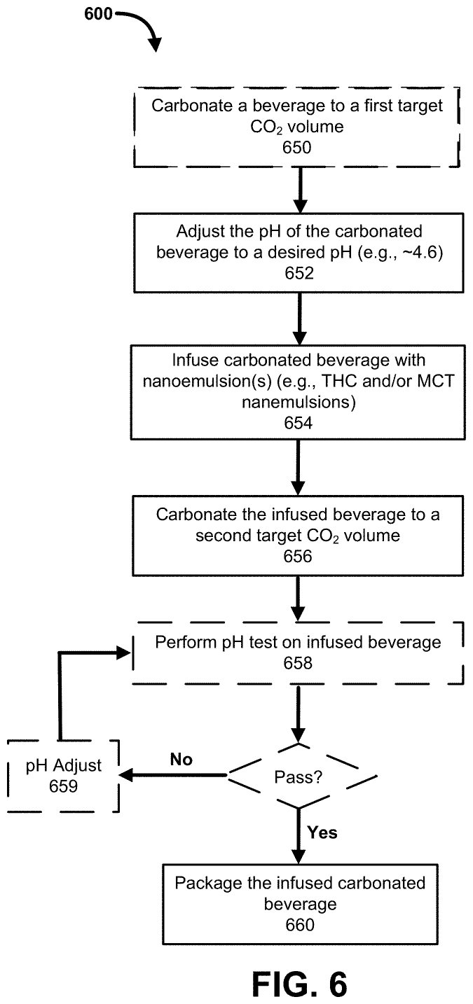

FIG. 6 is a diagram showing a method of preparing a cannabinoid-infused carbonated beverage, according to some embodiments. As shown in FIG. 6, the method 600 optionally begins with carbonating a beverage to a first target CO₂ volume 650. The pH of the carbonated beverage is then adjusted to a desired pH (e.g., in a range of between about 4 and about 5, or a value of about 4.6) 652. At 654, The pH-adjusted carbonated beverage is then infused with one or more nanoemulsions (e.g., a THC nanoemulsion) 654. An oil emulsion can also be added here to stabilize the dosage, as discussed above. The infused beverage is then carbonated to a second target CO₂ volume, at 656, to produce the cannabinoid-infused carbonated beverage, which can then be packaged 660. As an optional further step 658, a pH test can be performed on the beverage to determine whether a desired/target value has been achieved and/or to determine whether different locations within a tank of the beverage agree in pH value or range (i.e., indicating that the batch within the tank of the beverage is uniform or substantially/sufficiently uniform. If the pH test is conducted and not passed, a pH adjustment can be made 659, followed by another iteration of the pH test 658. If the pH test is conducted and passed, the beverage can be packaged 660.

A further example method of infusing a beverage with a nanoemulsion, and packaging of the infused beverage, according to some embodiments, is as follows:

1. Carbonate the beverage, within a tank, to a target CO₂ volume;
2. Sample the beverage, e.g., via two different ports of the tank, for pH measurement. The ports can, for example, be at different heights on the tank (e.g., a cylindrical conical tank) that are spaced far apart from one another, to determine whether the beverage pH is homogeneous or substantially uniform throughout the tank;
3. Adjust the beverage pH as needed (e.g., up to a pH maximum of ˜4.6);
4. Infuse (or “dose”) the beverage in the tank with THC nanoemulsion and an MCT emulsion, to produce an infused beverage;
5. Allow the infused beverage to sit overnight, to equilibrate the pH;
6. Purge a bottom line of the tank to drain at least a portion of the sediment that has settled to the tank bottom overnight. This process can facilitate the removal of any un-infused beer that remains in the bottom line;
7. Perform a further carbonation step, to a target CO₂ volume, on the infused beverage. Note that the infusion of the THC nanoemulsion and the MCT nanoemulsion may have decreased the CO₂ volume;
8. Allow the infused beverage to sit for at least 30 minutes;
9. Sample the infused beverage from two different ports of the tank, for potency testing and/or pH measurement;
10. When the results of the testing and/or measurement at the two different ports are in agreement or are substantially in agreement, begin packaging (e.g., canning or bottling) of the infused beverage;
11. Potency testing of the infused beverage can be performed by collecting a sample after the batch tank has been infused/dosed and homogenized. Target and acceptable ranges for the potency testing can be established. An acceptable potency variance can also be established (e.g., +/−15%).

a. If the measured potency is within the established acceptable range (e.g., a target amount +/−15%), the batch can be completed/packaged;

b. If the measured potency is not within the established acceptable range, the batch can be adjusted accordingly and retested prior to packaging, and

12. If the dosage amount and/or potency are found to deviate outside the specification range, production processes can be halted, and affected batch(es) can be quarantined (e.g., in accordance with a safety procedure) until the deviation is resolved (i.e., when the dosage amount and/or potency are within the specification range.

### Stability Assessment for Cannabinoid Emulsions in Beverage Production

A stability assessment of cannabinoid-infused beverages prepared according to methods set forth herein was conducted, along with evaluations of the efficacy of thermal processes in mitigating microbiological hazards for each product or product category. The emulsified cannabinoids were found to remain stable throughout the beverage processing thermal process, including exposure to a temperature of about 200° F. for 15 seconds to provide protection against vegetative pathogens (i.e., non-spore forming bacteria such as Salmonella spp., Listeria monocytogenes and E. coli 0157:H7) when applied to high-acid (pH<4.6), shelf-stable and refrigerated products.

### Stabilizing Cannabinoid Bioavailability in Beverages Packaged in Cans

Cannabinoids show variable stability in solutions such as blood and urine, depending on storage conditions and containers (Christophersen, 1986; Johnson et al., 1984; Garrett and Hunt, 1977). Beverages infused with cannabinoid emulsions such as those provided herewith, when packaged in metallic cans, rapidly (within days) decrease in availability of cannabinoids. The available dosage can be stabilized by adding an oil emulsion (e.g., without a cannabinoid) to the can before or at beverage packaging. Without being bound to any particular mechanism, it is believed that the can liner binds to cannabinoids in the emulsion, taking them out of the beverage. Adding the oil emulsion prevents this such that the cannabinoid available in the beverage loses less than 10% of its availability after at least one month refrigerated or room temperature storage.

Thus, in some embodiments, methods of packaging a beverage comprising a cannabinoid emulsion comprise packaging the cannabinoid infused beverage in a metallic can and adding an oil emulsion to the can. The oil emulsion can be added to the beverage before packaging, and/or added to the can before, during and/or after adding the beverage to the can, and/or added to the cannabinoid emulsion during or after processing.

The oil emulsion can be prepared by any method now known or later discovered. In some embodiments, the oil emulsion is prepared by any of the methods provided herewith that are also useful for preparing cannabinoid emulsions, for example homogenization of the oil and/or adding an additive or additives, e.g., vitamin E, lecithin derived phospholipids, a preservative, water, or any combination thereof.

An oil emulsion of any droplet size sufficient to be adequately miscible with the beverage can be utilized here. In some embodiments, the oil emulsion has a mean droplet size of 50, 100, 200, 300, or 400 nm or any size in between or outside of those sizes. In some embodiments, the oil emulsion is a microemulsion.

A preparation of any size triglyceride is suitable as the oil to use in the oil emulsion. Examples include short chain triglycerides (SCT), medium chain triglycerides (MCT), long chain triglycerides (LCT) or any combination including naturally occurring oils such as coconut oil. In some embodiments, the oil is MCT.

The amount of the oil emulsion to add to any particular beverage/can/cannabinoid combination can be determined without undue experimentation. For example, a cannabinoid infused beverage having 5 mg THC can be stabilized by these methods by adding 2.75 ml emulsified MCT (comprising about 20% MCT in water) to a 10 oz aluminum can.

This method can be generalized to any liquid food product that has an emulsified hydrophobic agent (e.g., a flavor component, nutraceutical, medication, etc.) since the addition of an oil emulsion to a liquid food product (e.g., beverage, soup, etc.) or a metallic can to which the food product is packaged, where the food product has an emulsified hydrophobic agent, also prevents the hydrophobic agent from being depleted from the liquid by binding to the liner.

Thus, a method of packaging a liquid in a metallic container having a liner is also provided. The method comprises adding the liquid and an oil emulsion to the metallic container, wherein

the liquid comprises a hydrophobic agent in an emulsion; and

the hydrophobic agent is available for ingestion in the liquid for a longer time than if the oil emulsion was not added.

In some of these embodiments, the hydrophobic agent is a cannabinoid. In other embodiments, the hydrophobic agent is in an emulsion, e.g., any of the cannabinoid emulsions described herein, including a nanoemulsion, a microemulsion or a nanoemulsion/microemulsion.

Any triglyceride oil can be utilized in these methods, as discussed above. In some embodiments, the triglyceride is medium chain triglyceride (MCT).

Any metallic container having a liner (e.g., aluminum, steel, etc.) can be utilized in these methods. Any liner known in the art in a can where the hydrophobic agent binds, e.g., epoxide liners such as BPA containing liners, should be treatable with these methods. A nonlimiting method for determining whether a hydrophobic agent appreciably binds to the liner comprises (a) adding the liquid with the hydrophobic agent to the can; (b) observing a reduction in the hydrophobic agent in the liquid over time; (c) scraping the liner off of the inside of a can where the reduction was observed; and (d) testing the scraped off liner for the presence of the hydrophobic agent.

Additionally provided is a liquid, such as a beverage, packaged by the above-identified method. In some embodiments, the beverage is a beer. In some of those embodiments, the beer is de-alcoholized. In other embodiments, the beverage is carbonated. In additional embodiments, the beverage has cannabinoid nanoemulsions. In further embodiments, the oil emulsion is an MCT emulsion.

### Cannabinoid Emulsion-Infused Solid Foods

A solid food comprising a cannabinoid emulsion is provided. In some embodiments, the cannabinoid emulsion is any of those described above. In some embodiments, the food is a gummy.

In various embodiments, the cannabinoid emulsion, when added to the food, is any one of the cannabinoid emulsions described above. In some embodiments, the cannabinoid emulsion is a nanoemulsion. In other embodiments, the cannabinoid emulsion is a microemulsion. In additional embodiments, the cannabinoid emulsion is a nanoemulsion/microemulsion.

In various embodiments, an effect of a cannabinoid in the food is at least 50% faster than the same amount of the cannabinoid in the food that is not in the nanoemulsion. In other embodiments, an effect of a cannabinoid in the food is at least 80% faster than the same amount of the cannabinoid in the food that is not in the nanoemulsion. In further embodiments, an effect of a cannabinoid in the food is at least 80% faster than the at least twice as much of the cannabinoid in the food that is not in the nanoemulsion.

In some of these food embodiments, the cannabinoid emulsion, before adding to the food ingredients, has less than about 70% water, e.g., 60, 50, 40, 30 or 20% water, or any value in between or outside that range. In some of those embodiments, the concentration of cannabinoid in the emulsion is 15-40 mg/ml, e.g., 20, 25, 30, or 35 mg/ml, or any concentration in between those concentrations.

Because the cannabinoid emulsions in many of the above-described food products have so little water, those emulsions are less heat tolerant, such that they begin to break down at 60° C., whereas the dilute emulsions infused into beverages tolerate temperatures up to 95° C. As such, the emulsions can break down during the preparation of the food products, particularly when that preparation involves a heating step (e.g., baking, heating gummy ingredients including gelatin to dissolve the ingredients).

In some embodiments, to increase the temperature tolerance and stability of the cannabinoid emulsions, maltodextrin is added. Without being bound to any particular mechanism, it is believed that the maltodextrin creates a protective layer around the emulsion droplets and takes the place of water in the emulsions if the emulsion dries during preparation of the solid food product.

In these embodiments, the amount of maltodextrin to be added to protect the cannabinoid emulsions during the preparation of any particular food product can be determined by the skilled artisan without undue experimentation. For gummy production, an amount of maltodextrin equivalent to 3-10 times the cannabinoids plus all solids (not water) in the emulsion is sufficient to protect the emulsion. In some embodiments, maltodextrin equivalent to 4-5 time the cannabinoids plus solids protects the emulsions in gummies.

Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims, which follow the examples.

### REFERENCES

Brenneisen R, 2007, Chemistry and Analysis of Phytocannabinoids (cannabinoids produced produced by Cannabis) and other Cannabis Constituents, In Marijuana and the Cannabinoids, ElSohly, ed.
Challapalli P V, Stinchcomb A L., 2002, Int J Pharm. 241(2):329-39.
Christophersen, 1986, J. Anal. Toxicol. 10:129-31.
El-Alfy et al., 2010, Pharmacology Biochemistry and Behavior 95 (4): 434-42.
Garrett E R and Hunt C A, 1977, J. Pharm Sci. 66:395-407.
Iffland et al., October 2016, European Industrial Hemp Association
Johnson et al., 1984, J. Anal. Toxicol. 8:202-4.
Kosseva M R, 2017, Dealcoholization—an overview I ScienceDirect Topics
Lanz et al., 2016, PLoS ONE 11(1):e0147286
Le Herbe, 2016, White Paper: The art and Science of Cannabis Beverages.
Lemberger et al., 1970, Science 170:1320-2.
Lipnizki, 2014, ReferenceWorkEntry_BeerDealcoholization.pdf
McGilveray I J, 2005, Pain Res Manag 10 Suppl A:15A-22A
Scheuplein R J, 1967, J Invest Dermatol. 48(1):79-88.
PCT Patent Publication WO 2016/123475.
PCT Patent Publication WO 2019/014631.
U.S. Pat. No. 9,199,960.
US Patent Application Publication 2016/0143972.
US Patent Application Publication 2018/0042845.
US Patent Application Publication 2018/0116240.

In view of the above, it will be seen that several objectives of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1-119. (canceled)

120. A food or beverage comprising a cannabinoid emulsion.

121. The food or beverage of claim 120, wherein the cannabinoid emulsion is a cannabinoid nanoemulsion.

122. The food or beverage of claim 121, wherein the cannabinoid nanoemulsion has an average droplet size of 75 nm or smaller.

123. The food or beverage of claim 121, wherein the cannabinoid nanoemulsion has an average droplet size of 50 nm or smaller.

124. The food or beverage of claim 120, wherein the cannabinoid emulsion is a nanoemulsion/microemulsion.

125. The food or beverage of claim 124, wherein the cannabinoid nanoemulsion/microemulsion comprises droplet sizes of 75 nm to 150 nm.

126. The food or beverage of claim 120, wherein the cannabinoid emulsion comprises CBD or THC.

127. The food or beverage of claim 120, which is a beverage.

128. The beverage of claim 127, wherein the beverage is a beer.

129. The beverage of claim 128, wherein the beer is de-alcoholized.

130. The beverage of claim 129, wherein aroma that was volatilized when the beer was de-alcoholized is captured and infused back into the de-alcoholized beer.

131. The beverage of claim 129, wherein the beer is de-alcoholized by a low temperature vacuum de-alcoholizer machine.

132. The food or beverage of claim 120, wherein the emulsion is prepared by
freezing a portion of a Cannabis plant to produce frozen Cannabis, wherein the Cannabis plant comprises at least one cannabinoid;
submerging the frozen Cannabis in at least 95% ethanol to produce a mixture;
storing the mixture for a duration sufficient to convert the ethanol into an ethanol-cannabinoid solution;
removing the ethanol-cannabinoid solution from the mixture;
concentrating the ethanol-cannabinoid solution using an evaporator, to produce a concentrated ethanol-cannabinoid solution;
distilling the concentrated ethanol-cannabinoid solution to an ethanol concentration of between about 5% and about 10%, to produce a cannabinoid concentrate;
heating the cannabinoid concentrate sufficient to decarboxylate the cannabinoid concentrate;
performing a distillation of the cannabinoid concentrate;
adding an oil comprising C14 triglycerides to the distilled cannabinoid concentrate; and
processing the cannabinoid concentrate to form a cannabinoid emulsion.

133. The food or beverage of claim 132, wherein the processing of cannabinoid concentrate into a cannabinoid emulsion is by microfluidizing and/or ultrasonicating.

134. The food or beverage of claim 124, wherein an effect of a cannabinoid therein is at least 50% faster than the same amount of the cannabinoid in the food or beverage that is not in the nanoemulsion.

135. The food or beverage of claim 124, wherein an effect of the cannabinoid therein lasts about as long as the same amount of the cannabinoid in the food or beverage that is not in the emulsion.

136. The food or beverage of claim 124, wherein
an effect of a cannabinoid therein is at least 50% faster than the same amount of the cannabinoid in the food or beverage that is not in the nanoemulsion and
an effect of the cannabinoid therein lasts about as long as the same amount of the cannabinoid in the food or beverage that is not in the emulsion.

137. The food or beverage of claim 125, wherein
an effect of a cannabinoid therein is at least 80% faster than the same amount of the cannabinoid in the beverage that is not in the nanoemulsion/microemulsion, and
the effect lasts about as long as the same amount of the cannabinoid in the beverage that is not in the nanoemulsion/microemulsion.

138. The food or beverage of claim 124, comprising droplets less than 75 nm in addition to droplets between 75 nm and 150 nm, wherein
an effect of a cannabinoid therein is at least 50% faster than the same amount of the cannabinoid in the food or beverage that is not in a nanoemulsion; and
an effect of a cannabinoid therein lasts at least 4-5 times longer than the same amount of the cannabinoid in the food or beverage that is not in a nanoemulsion.

129. The beverage of claim 127, further comprises an oil emulsion, wherein the oil emulsion does not comprise a cannabinoid.

140. The beverage of claim 129, wherein the oil emulsion is a medium chain triglyceride (MCT) emulsion.

141. The beverage of claim 129, wherein the cannabinoid emulsion is available for ingestion in the beverage for a longer time than if the oil emulsion was not added.

142. The beverage of claim 129, packaged in a metallic container having a liner.

143. The beverage of claim 142, wherein the metallic container is an aluminum can.
